(19) United States
(12) Patent Application Publication
(10) Pub. No.: US 2021/0074191 A1
(43) Pub. Date: Mar. 11, 2021

(54) VISUAL INDICATOR MARKER LOCATOR

(71) Applicant: Rhino Marking & Protection Systems, Minneapolis, MN (US)

(72) Inventors: Scott Landes, Bloomington, MN (US); Chris Thome, Inver Grove Heights, MN (US)

(21) Appl. No.: 17/013,125

(22) Filed: Sep. 4, 2020

Related U.S. Application Data
(60) Provisional application No. 62/896,886, filed on Sep. 6, 2019.

(51) Int. Cl. G09F 19/22

(52) U.S. Cl. CPC G09F 19/22

(57) ABSTRACT

An outdoor signage having a visual indicator for marking the location of a utility line or the status of a utility line service proximate the outdoor signage inserted into the ground. The visual indicator of the outdoor signage located at an above ground end. The visual indicator having a primary color in the form of the geometrical shape, and the configuration of the above ground end of the signage forming at least a portion of the geometrical shape in conjunction with the primary color. The outdoor signage also having three contiguous shapes including the above ground end and the below ground end that is in the form of a point, such that the contiguous shape allows easy insertion of the signage into the ground proximate the location of the utility line while simultaneously providing a visual warning indicator concerning the utility line or a visual status indicator concerning the status of the utility service to an ordinary observer.

### RELATED APPLICATION

The present application claims the benefit of U.S. Provisional Application No. 62/896,886 entitled “STOP STICK LOCATOR”, filed Sep. 6, 2019, which is incorporated herein by reference in its entirety.

### TECHNICAL FIELD

The present invention relates generally to an outdoor signage marker, more particularly an outdoor marker post that is rigid and easily and partially insertable into the ground, the marker post providing a visual indicator as to the location or status of a gas line or gas service.

### BACKGROUND

Traditionally, marker posts are used to place an above ground warning that an underground pipe or electric line is buried in the soil. The marker post must be visually and physically unobtrusive, yet be able to warn a person that an underground utility exists at the particularly marked location. In addition, the marker post must be able to withstand the environment for an extended period of time. The marker post should also be able to remain embedded at the location of the underground utility in order to continue to convey a warning message of the existence of an underground hazard to those who may be in the proximity of the underground hazard.

One problem with traditional marker posts, such as paint and flags, is that no indication of survey completion is indicated by their use. A potential excavator may assume that a location survey has been completed without any issues when it has not been. The excavator may begin digging before all utilities have been located, for example in a situation when the excavator is the only person on site.

Accordingly, there is a need in the industry for cost-effective, rigid signage that can provide a visual indicator as to the location or status of a gas line or gas service.

### SUMMARY

The present invention of a rigid signage substantially addresses the aforementioned needs of the industry. The rigid signage is a visual indicator marker that comprises an above ground end connected to a below ground end by an intermediate middle portion having two substantially parallel and vertical edges that taper into a rounded point to form the below ground end of the post. The rigid signage further comprises a substrate material having two opposing outwardly facing surfaces having at least one colored ink layering applied thereto, the opposing outwardly facing surfaces configured to have three contiguous shapes, and the rigid signage providing a visual indicator as to the location or status of a utility line or utility service, such as a gas or electrical line or gas or electrical service.

In a preferred embodiment, the visual indicator marker comprises an above ground end configured to provide a visual indicator having a geometrical shape and a middle portion having two substantially parallel and vertical edges that taper into a rounded point to form a below ground end of the visual indicator marker.

In some aspects, the visual indicator marker comprises an above ground end having three edges angled such that they form three adjacent edges of an octagon and a middle portion having substantially two parallel and vertical edges that taper into a rounded point to form a below ground end of the visual indicator marker.

In some aspects, the visual indicator marker comprises an above ground end having a top rounded configuration of a circle and a middle portion having two substantially parallel and vertical edges that taper into a rounded point to form a below ground end of the visual indicator marker.

In some aspects, the visual indicator marker comprises an above ground end having opposing rounded corners and a middle portion having two substantially parallel and vertical edges that taper into a rounded point to form a below ground end of the visual indicator marker.

In one embodiment, the visual indicator marker comprises a substrate material having at least one colored ink layering directly applied to the substrate material on at least one of the outwardly facing surfaces, preferably at least one colored ink layering applied to both of the outwardly facing surfaces. In some aspects, the at least one colored ink layering comprises at least one color, preferably two or more colors, and in some preferred aspects multi-colored.

In some aspects, the substrate material is an aluminum composite, fiberglass material, plastic material or other metal composite. In some aspects, the at least one colored ink layering is a coating layer or a printed layer, preferably a digitally printed layer. In some aspects, the at least one colored ink layering is coated with a UV coating to form a layered structure, the at least one colored ink layering intermediate the substrate material and the UV coating.

In some aspects, the rigid, continuous post body has two opposing outwardly facing surfaces that are substantially flat surfaces having the colored ink layering printed or coated thereon. In some aspects, the rigid, continuous body also has two side face surfaces. In some aspects, the two opposing outwardly facing surfaces have a width that is greater than the two side face surfaces.

In some aspects, the at least one colored ink layering provides a warning indicator proximately located the above ground end. In some aspects, the at least one colored ink layering provides a status indicator proximately located the above ground end. In some aspects, the above ground end provides a geometrical shape for the top portion of the warning indicator or the status indicator. In some aspects, the warning indicator or status indicator has a colored geometrical shape, such as an octagon, circle, square or triangle. In some aspects, the colored geometrical shape is provided in red, green or yellow, such that the combination of the color and geometric shape provides a visual warning indicator or a visual status indicator. In some aspects, the visual warning indicator or the visual status indicator relates to a utility, such as an electrical line, electrical service, gas line or gas service.

In some aspects, the at least one colored ink layering provides a written warning message and/or written status message. In some aspects, the written warning message is provided proximate the warning or status indicator, wherein the coloring of the written warning message is a different color than the color of the warning or status indicator. In some aspects, the written status message is provided proximate the warning or status indicator, wherein the coloring of the written status message is a different color than the color of the warning or status indicator. In some aspects, the colored geometrical shape and written warning message provide the visual warning indicator. In some aspects, the colored geometrical shape and the written status message provide the visual status indicator.

In some aspects, the at least one colored ink layering provides a utility contact information. In some aspects, the utility contact information is provided proximate the warning or status indicator, wherein the coloring of the utility contact information is a different color than the color of the warning or status indicator.

In some aspects, the at least one colored ink layering provides one or more messages or logos, preferably located proximate the middle portion. In some aspects, the at least one colored ink layering provides the universal call before you dig number 811. In some aspects, the one or more messages, logos, or universal call before you dig number is provided in a color that has a substantially different visual appearance than the warning or status indicator.

In some aspects, the colored ink layering on the two opposing outwardly facing surfaces is the same. In some aspects, the colored ink layering on the two opposing outwardly facing surfaces is different. In some aspects, the colored ink layering provides a different language on the two opposing outwardly facing surfaces. In some aspects, the colored ink layering on the two opposing outwardly facing surfaces is different, such that each side provides a different visual indicator.

In some aspects, the width of the two opposing flat surfaces proximate the middle portion of the visual indicator marker is between about 1 inch and about 12 inches, preferably between about 1.5 inches and about 6 inches, more preferably between about 2 inches and about 3 inches.

In some aspects, a length between the above ground end the below ground end is between about 6 inches and about 36 inches, preferably between about 10 inches and about 30 inches, more preferably between about 12 inches and about 20 inches.

In some aspects, the substrate material is in the form of a sheet, such that a thickness of the substrate material is between about 2 mm and about 5 mm, preferably between about 2.5 mm and about 4 mm, most preferably about 3 mm.

In one embodiment, the warning message includes a printed stop sign, the top of which uses the three edges of the above ground end of the visual indicator marker. In one embodiment, the facility operator name and contact information is displayed along with a warning message.

In one embodiment, the warning message includes a printed red or green circle, the top of which uses the rounded circle configuration of the above ground end of the visual indicator marker. In one embodiment, the circle portion is red with a written message relating to the utility service being off. In another embodiment, the portion is green with a written messaging relating to the utility service being on.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a top, front view of a visual indicator marker according to certain embodiments of the present invention.

FIG. 2 is a top, back view of the visual indicator marker of FIG. 1, according to certain embodiments of the present invention.

FIG. 3 is a perspective view of the visual indicator marker of FIGS. 1-2, according to certain embodiments of the present invention.

FIG. 4 is a top plan view of a visual indicator marker without any color or messaging, the top plan view being the same for the front and back sides of the visual indicator marker.

FIG. 5 is a side view of the visual marker of FIG. 4, the side view for each of the sides being the same.

FIG. 6 is a top end view of the visual marker of FIG. 4.

FIG. 7 is a bottom end view of the visual marker of FIG. 4.

FIG. 8A is a top, front view of a visual indicator marker according to certain embodiments of the present inention.

FIG. 8B is a top, back view of the visual marker of FIG. 8A, according to certain embodiments of the present invention.

FIG. 9A is a top, front view of a visual indicator marker according to another embodiment of the present invention.

FIG. 9B is a top, back view of the visual marker of FIG. 9A, according to another embodiments of the present invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

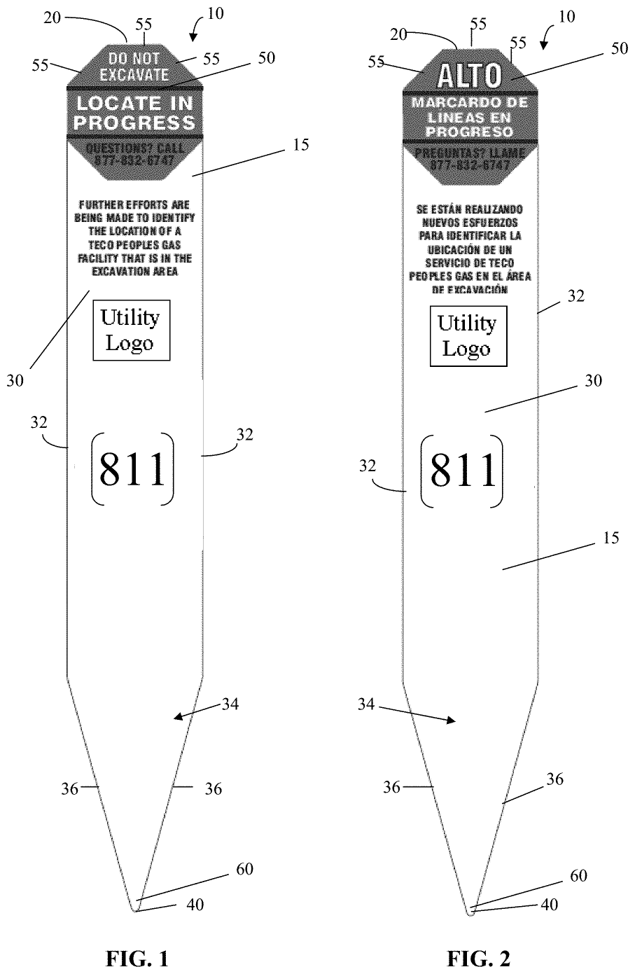

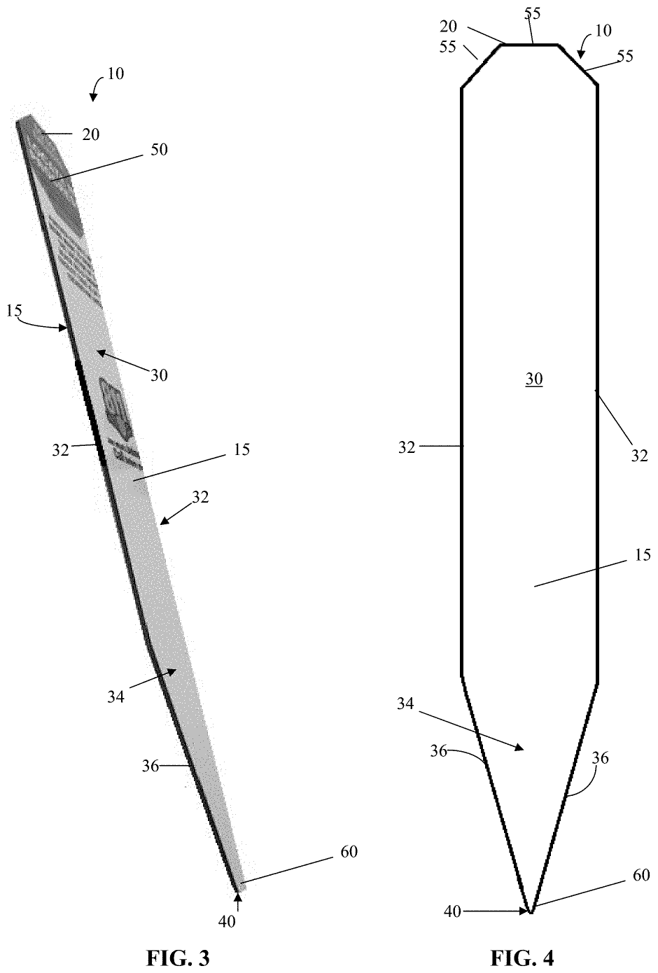

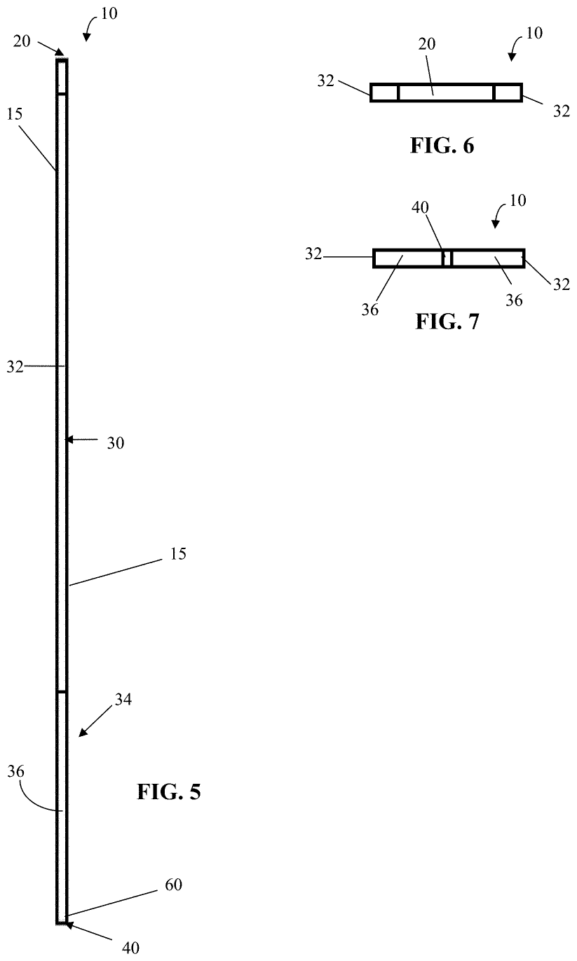

Referring now generally to the figures, the present invention of a rigid signage that provides a visual indicator marker 10 is further discussed. As provided in FIGS. 1-9A, the visual indicator marker 10 has an above ground end 20 connected to a below ground end 40 by an intermediate middle portion 30. The intermediate portion 30 comprises two substantially parallel edges 32 that have a vertical configuration relative to each of the above ground end 20 and below ground end 40. At least one of the two substantially parallel, vertical edges 32 has a taper portion 34 that causes at least one of the tapered edges 36 to converge with the other edge 34, preferably the taper portion 34 causes both of the tapered edges 36 to converge, to form a point, preferably a rounded point, proximate the below ground end 40.

The visual indicator marker 10 is preferably comprised of a substrate material having two opposing outwardly facing surfaces 15 having at least one colored ink layering applied thereto, such that the opposing outwardly facing surfaces 15 have one or more colors applied to the substrate material. The opposing outwardly facing surfaces 15 are also configured to have at least three contiguous shapes, and the visual indicator marker 10 having at least one visual indicator 50 proximately located the above ground end 20 as to provide the location or status of a utility line or utility service, such as a gas or electrical line or gas or electrical service, to an ordinary observer.

The visual indicator 50 preferably comprises a geometrical shape that is comprised of the shape of at least a portion of the above ground end 20 and a coloring of the colored ink layering. In some aspects, the geometrical shape of the visual indicator 50 is an octagon, circle, triangle, square or the link.

In a preferred embodiment, the visual indicator marker 10 comprises an above ground end 20 configured to provide the visual indicator 50 having a geometrical shape and colored ink layering proximate the above ground end 20 relating to the geometrical shape, and the visual indicator marker 10 having a middle portion 30 having two substantially parallel and vertical edges 32 that taper into a rounded point 40 to form a below ground end 60.

In some aspects, as shown best in FIGS. 1-2, the visual indicator marker 10 has a visual indicator 50 proximate the above ground end 20 that is octagon-shaped. The visual indicator 50 comprised of three adjacent angled edges 55 of the above ground end 20 and a colored ink layering (shown in FIGS. 1-2 as the color red). The three adjacent angled edges 55 forming three adjacent edges 55 of an octagon proximate the above ground end 20, which in conjunction with the colored ink layering form the octagon-shaped visual indicator 50.

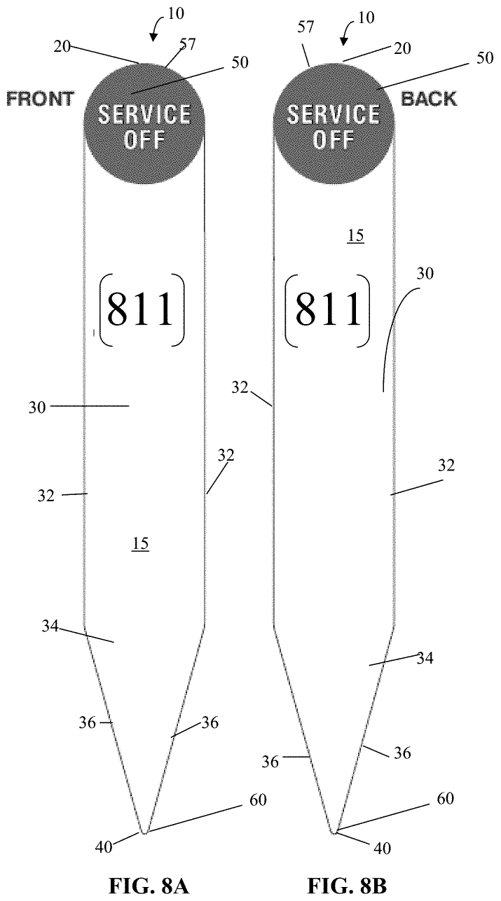

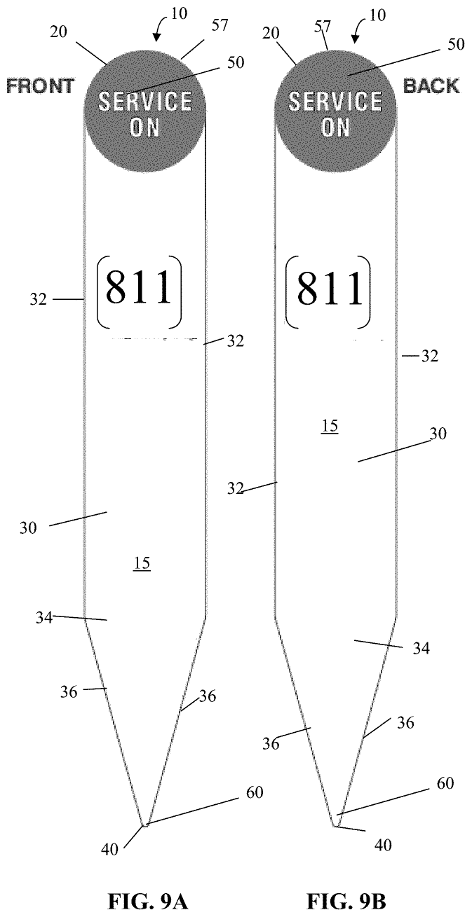

In some aspects, as shown in FIGS. 8A-8B and FIGS. 9A-9B, the visual indicator marker 10 comprises an above ground end 20 that is circular-shaped. The visual indicator 50 comprised of the top rounded configuration 57 of the above ground end 20 and a coloring of the colored ink layering (shown in FIGS. 8A-8B as red, and shown in FIGS. 9A-9B as green). The top rounded configuration 57 forming the top of a circle, which in conjunction with the colored ink layering forms the circular-shaped visual indicator 50.

The visual indicator marker 10 preferably comprises at least one colored ink layering directly applied to the substrate material on at least one of the outwardly facing surfaces, more preferably at least one colored ink layering applied to both of the outwardly facing surfaces. In some aspects, the at least one colored ink layering comprises at least one color, preferably two or more colors, and in some preferred aspects multi-colored. As shown in FIGS. 1-2 and 8A-9B, the coloring of the visual indicator 50 is at least one color, preferably at least two colors, and in some aspects three or more colors, to effectuate the overall shape of the visual indicator 50 and any messaging corresponding to the visual indicator 50. In a preferred embodiment, the primary color corresponding to the geometric shape of the visual indicator 50 is preferably red or green, while other colors are contemplated.

In some aspects, the body of the visual indicator marker 10 proximate the middle portion 30 also has at least one color. In some aspects, the primary coloring of the visual indicator marker 10 proximate the middle portion 30 is one color, such as white, with at least one different color corresponding to any messaging, such as black. In some aspects, the messaging proximate the middle portion 30 may comprise one or more colors.

The visual indicator 50 may be a warning indicator, such as shown in FIGS. 1-2, relating to the existence or proximity of a utility line, such as an electrical line or a gas line in the general area of the visual indicator marker 10 inserted into the ground. The visual indicator 50 may alternatively be a status indicator, such as shown in FIGS. 8A-8B and FIGS. 9A-9B), relating to the status of a utility service, such as an electrical service or a gas line service in the general area of the visual indicator marker 10 inserted into the ground. The visual indicator marker 50 having a visual indicator 50, whether functioning as a warning indicator or a status indicator, preferably comprises one or more colored ink layerings applied to the substrate material, whereby the one or more colored ink layerings comprises one or more ink colors.

Preferably the one or more colored ink layerings comprises one color proximately located the above ground end 20 and a different color proximately located the middle portion 30 and/aor the below ground end 40. The primary color of the middle portion 30 is preferably a light color, such as white, such that the primary color of the visual indicator 50 stands out, as does any messaging on the visual indicator marker 10.

In some aspects, the visual indicator 50 has a written warning message and/or written status message proximate the warning or status indicator, wherein the coloring of the written warning message is a different color than the color of the warning or status indicator. In some aspects, the written status message is provided proximately within the primary color of the warning or status indicator, wherein the coloring of the written status message is a different color than the primary color of the warning or status indicator. In some aspects, the visual warning indicator 50 comprises the geometrical shape of the above ground end 20, the colored geometrical shape proximate the above ground end 50, and the written warning message provided within the primary color of the geometrical shape, such as shown in FIGS. 1-2. In some aspects, the visual warning indicator 50 comprises the geometrical shape of the above ground end 20, the colored geometrical shape proximate the above ground end 50, and the written status message provided within the primary color of the geometrical shape, such as shown in FIGS. 8A-8B and FIGS. 9A-9B.

In some aspects, the one or more colored ink layering provides a written contact information for a utility company. In some aspects, the utility contact information is provided proximate the warning or status indicator, wherein the coloring of the utility contact information is a different color than the primary color of the warning or status indicator.

In some aspects, the one or more colored ink layering provides one or more messages or logos, preferably located proximate the middle portion 30. In some aspects, the logo relates to the utility company responsible for the utility line. In some aspects, the one or more colored ink layering provides the universal call before you dig number 811. In some aspects, the one or more messages, logos, or universal call before you dig number is provided proximate the middle portion 30.

The substrate material is preferably a rigid material providing structure to the visual indicator marker 10. In some aspects, the substrate material provides enough rigidity such that the visual indicator marker 10 can be inserted into the ground by tapping the above ground end 20 with a device, such as a hammer, without affecting the integrity of the substrate material. In some aspects, the substrate material is an aluminum composite, fiberglass material, plastic material or other metal composite. The colored ink layering applied to the substrate material can be a coating layer or a printed layer, preferably a digitally printed layer. In some aspects, the colored ink layering applied to the substrate material is coated with an aliphatic urethane coating. In some aspects, the aliphatic urethane coating is a UV coating applied to the colored ink layering to form a layered structure, the colored ink layering intermediate the substrate material and the UV coating.

In some aspects, the aliphatic urethane composition applied to the colored ink layering contains pendant hydroxyl groups that can be crosslinked with one or more activators, which can be initiated by UV irradiation with an irradiance less than 0.5 J/cm², partitioning between the phases and/or the generation of other functional groups by the reaction of the crosslinker with the backbone by the hydroxyl functionality of the aliphatic urethane composition.

In some aspects, the at least one ink layer comprises a material that is compatible with the substrate material, such as a liquid plastic or other polymer material in liquid form. In some aspects, the ink layer may be a UV ink layer that cures upon UV irradiation with an irradiance less than 0.5 J/cm².

The substrate material is preferably provided in the form of a sheet, such that the two opposing outwardly facing surfaces have a width that is greater than that of the two side face surfaces, the two side face surfaces defining the thickness of the substrate material.

In some aspects, the colored ink layering on the two opposing outwardly facing surfaces 15 is the same, such as shown in FIGS. 8A-8B and 9A-9B, respectively. In some aspects, the colored ink layering on the two opposing outwardly facing surfaces 15 is different. In some aspects, the colored ink layering provides a different language on the two opposing outwardly facing surfaces 15, such as shown between FIGS. 1 and 2. In some aspects, the colored ink layering on the two opposing outwardly facing surfaces 15 is different, such that each side provides a different visual indicator.

The two opposing flat surfaces 15 of the visual indicator marker 10 preferably has a width spanning between the two substantially parallel, vertical edges 32 proximate the middle portion 30 that is between about 1 inch and about 12 inches, preferably between about 1.5 inches and about 6 inches, more preferably between about 2 inches and about 3 inches.

The visual indicator marker 10 preferably has a length spanning between the above ground end 20 and the below ground end 40 that is between about 6 inches and about 36 inches, preferably between about 10 inches and about 30 inches, more preferably between about 12 inches and about 20 inches.

Preferably the substrate material of the visual indicator marker 10 is in the form of a sheet, such that a thickness between the two opposing outwardly facing surfaces 15 is between about 2 mm and about 5 mm, preferably between about 2.5 mm and about 4 mm, most preferably about 3 mm.

In one preferred embodiment, the visual indicator 50 has the geometrical shape of an octagon with the primary color of red and the above ground end 20 has three angled edges of the octagon, such that the visual indicator 50 is a warning visual indicator resembling a stop sign, such as shown in FIGS. 1 and 2. In some aspects, the utility contact information is displayed within the primary red color of the visual indicator 50. In some aspects, the visual warning indicator also comprises a warning message displayed within the primary red color of the visual warning indicator.

In another preferred embodiment, the visual indicator 50 has the geometrical shape of a circle with the primary color being either red or green and the above ground end 20 having a rounded top configuration, such that the visual indicator 50 is a status visual indicator resembling a stop light, such as shown in FIGS. 8A-8B with the primary color being red and FIGS. 9A-9B with the primary color being green. In some aspects, the utility contact information is displayed within the primary color of the visual warning indicator 50. In some aspects, the visual warning indicator also comprises a status message displayed within the primary color of the visual indicator 50. In some aspects, the status message relates to the status of the utility, such as the electrical line or gas line. As shown in FIGS. 8A-8B, the primary red color of the visual indicator 50 and the status message contained therein indicates that the utility service is off or not functioning. As shown in FIGS. 9A-9B, the primary green color of the visual indicator 50 and the status message contained therein indicates that the utility service is on or functioning.

The visual marker locator 10 can be utilized to assist an ordinary observer in relation to a utility. Such assistance may include the existence of a buried electrical line or gas line proximate the location of the visual marker locator 10 being inserted into the ground. Such assistance may alternatively include the status of a buried electrical line or gas line proximate the location of the visual marker locator 10 being inserted into the ground, including the status of the utility service being on or off. One or more visual marker locators 10 can be used to provide such visual assistance. In some aspects, the visual marker locators 10 are relatively lightweight, such that they weigh less than about ½ pound each, preferably less than about ⅓ pound, and more preferably less than about ¼ pound. The visual marker locators 10 can also be easily stacked relative to each other, such that a stack of the visual marker locators 10 can be contained within a container, such as a box, and easily carried by a person and inserted into the ground as needed. One or more of the visual marker locators 10 inserted into the ground proximate a utility can provide a person with a necessary warning or status of the utility.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above.

The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A signage having a visual indicator for marking the location of a utility line or the status of a utility line service, the signage comprising:
a substrate material having at least one colored layering applied to a first side of the substrate material and at least one colored layering applied to a second side of the substrate material, the first and second sides with the applied colored layerings defining two opposing outwardly facing surfaces, the two opposing outwardly facing surfaces configured to have at least three contiguous shapes comprising an above ground end having a portion of a geometrical shape, the above ground end connected to a below ground end by an intermediate middle portion, the intermediate middle portion having two substantially parallel and vertical edges that taper into a rounded point to form the below ground end; and
a visual indicator proximately located the above ground end configured to provide a proximate location of a utility line or a status of a utility service, the at least one colored layering proximate the visual indicator provided as a primary color in the shape of the geometrical shape, wherein the portion of the geometrical shape of the above ground end forming a top portion of the geometrical shape.

2. The signage of claim 1, further comprising a warning message contained within the visual indicator, wherein the warning message indicates a location of a utility line.

3. The signage of claim 1, wherein the primary color is red and the geometrical shape is an octagon.

4. The signage of claim 3, further comprising a warning message contained within the red primary color of the octagon shape.

5. The signage of claim 1, further comprising a status message contained within the visual indicator, wherein the status message indicates to an ordinary observer whether a utility service is on or off.

6. The signage of claim 1, wherein the primary color is red or green and the geometrical shape is a circle.

7. The signage of claim 6, further comprising a status message contained within the red primary color of the circle shape, wherein the status message indicates to an ordinary observer the utility service is off.

8. The signage of claim 6, further comprising a status message contained within the green primary color of the circle shape, wherein the status message indicates to an ordinary observer the utility service is on.

9. The signage or claim 1, further comprising a warning message contained within the primary color and the geometrical shape of the status indicator, wherein the warning message is a different color than the primary color, and wherein the warning message indicates to an ordinary observer a location of a utility line.

10. The signage of claim 1, further comprising a status message contained within the primary color and the geometrical shape of the status indicator, wherein the status message is a different color than the primary color, and wherein the status message indicates to an ordinary observer whether a utility service is on or off.

11. The signage of claim 1, wherein the middle portion has a primary color that is different than the primary color of the visual indicator.

12. The signage of claim 11, wherein the middle portion comprises a contact information for a utility company, a logo for a utility company, a universal call number relating to finding a utility line, or combinations thereof.

13. The signage of claim 1, wherein the substrate material is an aluminum composite, fiberglass material, plastic material, or metal composite.

14. The signage of claim 1, wherein the colored ink layering applied to the substrate material is a coating layer or a printed layer.

15. The signage of claim 14, wherein the colored ink layering applied to the substrate material is a digitally printed layer.

16. The signage of claim 14, wherein the colored ink layering applied to the substrate material is coated with an aliphatic urethane coating.

17. The signage of claim 1, wherein a width of each of the two opposing flat surfaces is between about 1.5 inches and about 6 inches.

18. The signage of claim 1, wherein a length spanning between the above ground end and the below ground end is between about 10 inches and about 30 inches.

19. The signage of claim 1, wherein a width of each of the two opposing flat surfaces is between about 2 inches and about 3 inches, a length spanning between the above ground end and the below ground end is between about 12 inches and about 20 inches, and a thickness between the two opposing outwardly facing surfaces is between about 2 mm and about 5 mm.

20. A method of providing a visual indicator to an observer concerning a location of a utility line or a status of a utility line service, the method comprising:
providing a signage comprising:
a substrate material having at least one colored layering applied to a first side of the substrate material and at least one colored layering applied to a second side of the substrate material, the first and second sides with the applied colored layerings defining two opposing outwardly facing surfaces, the two opposing outwardly facing surfaces configured to have at least three contiguous shapes comprising an above ground end having a portion of a geometrical shape, the above ground end connected to a below ground end by an intermediate middle portion, the intermediate middle portion having two substantially parallel and vertical edges that taper into a rounded point to form the below ground end; and
a visual indicator proximately located the above ground end configured to provide a proximate location of a utility line or a status of a utility service, the at least one colored layering proximate the visual indicator provided as a primary color in the shape of the geometrical shape, wherein the portion of the geometrical shape of the above ground end forming a top portion of the geometrical shape; and
inserting the below ground end of the signage into the ground proximate a location of a utility line or a status of a utility line service, such that the visual indicator proximately located the above ground end provides the location of the utility line or the status of the utility line service to an ordinary observer.
